(19) United States
(12) Patent Application Publication
(10) Pub. No.: US 2020/0056860 A1
(43) Pub. Date: Feb. 20, 2020

(54) Camouflaged Cover Assembly

(71) Applicant: Todd M. Glaser, Miami Beach, FL (US)

(72) Inventor: Todd M. Glaser, Miami Beach, FL (US)

(21) Appl. No.: 16/105,826

(22) Filed: Aug. 20, 2018

(51) Int. Cl. F41H 3/00; B44F 9/00; B05B 15/16; E01C 13/08

(52) U.S. Cl. CPC F41H 3/00; B44F 9/00; B44F 9/02; E01C 13/08; B05B 15/16

(57) ABSTRACT

A camouflaged cover assembly covers a valve box and appears like surrounding ground cover in order to hide the cover by matching the cover to surrounding ground coverage. The valve box can house items like sprinkler heads, valves, and plumbing fittings. The cover can include a decoration to match the surrounding ground coverage. For example, the decoration can be artificial turf that matches a variety of grass that surrounds the valve box. The decoration can match other types of surrounding ground coverage such as mulch and wood chips.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

### Field of the Invention

The invention relates to devices for concealing covers for valves and sprinkler heads.

### Description of the Related Art

Valves, pipes, fittings, conduits and the like are placed below the surface of the ground. In the case of valves and fittings, a box is placed in the ground to house the valve or fitting. The box separates the valve or fitting from the surrounding earth. An uncovered box, open pipe, or open conduit are pitfalls in which an unsuspecting person could step.

Covers are added to boxes and conduits to prevent accidents. For the same reason, manhole covers are placed over pipes.

Popup sprinkler heads have covers on their tops. When the sprinkler head extends, the sprinkler head pushes upward and lifts the cover. When the water pressure subsists, the sprinkler head retracts and lowers the cover to a position that is flush with the ground.

The covers that are used are typically made of a black resin or metal. These covers are unsightly when they are located in landscaped areas because they contrast the surrounding areas. For example, a black cover placed in the middle of a lawn or golf course fairway detracts from the beauty of the grass. In the case of a golf-course fairway, a cover can cause a golf ball that strikes the cover to bounce unpredictably, in a way that is not desired by golfers.

Similar to covers in grassy areas, covers that contrast any surrounding surface create an unsightly distraction. For example, a black cover placed in a mulched garden or a black cover placed in a white concrete deck create a distraction to onlookers.

Accordingly, a need exists to allow covers to be used while hiding the covers from sight.

### BRIEF SUMMARY OF THE INVENTION

An object of the invention is to provide a camouflaged cover assembly that overcomes the disadvantages of the devices of this general type and of the prior art.

With the foregoing and other objects in view there is provided, in accordance with the invention, a camouflaged cover assembly for hiding the cover by blending the top of the cover to match a surface of surrounding ground. The cover can be a cover for a box such as a valve box, a hole, or a conduit that is placed in ground. The camouflaged cover assembly includes a cover and a decoration. The cover is configured to limit access to the opening of the box, pipe, or conduit. The cover has a top surface. The decoration matches the surface of the ground in which the box, fitting, hole, or conduit is place. The decoration is disposed on the top surface of the cover.

If the surrounding ground is covered with grass, then the decoration can be artificial turf. If the surrounding ground is a garden covered with woodchips, then the decoration can be a plurality of wood chips. If the surrounding ground is cement or concrete, then the decoration can be a piece of cement or concrete. If the surrounding ground is covered in tiles, then the decoration can be a plurality of tiles. If the surrounding ground is a wood floor, then the decoration can be matching wood.

The decoration can be a photograph matching the surface of the ground. For example, if grass covers the surrounding ground, then the decoration can be a photograph of turf. If the surrounding ground is covered with woodchips, then the decoration can be a photograph of woodchips.

The camouflaged cover assembly can include an elastomer layer. The elastomer layer can be disposed between the top surface of the cover and the decoration. The thickness and material of the elastomer layer can be modified to give the camouflaged cover assembly similar hardness and elasticity as the surrounding material. By adjusting the physical qualities of the surrounding materials by changing the material and thickness of the elastomer layer, the camouflaged cover assembly becomes even more difficult to distinguish from the surrounding material. This is particularly true when the camouflaged cover assembly is on a field or golf course where a ball might bounce on the camouflaged cover assembly.

The decoration of the camouflaged cover assembly can be shaped to be congruent and thereby completely cover the top surface of the cover.

The camouflaged cover assembly can have additional information printed on the decoration. For example, a number representing a distance from the camouflaged cover assembly to a golf hole can be printed on the decoration.

In accordance with the objects of the invention, a method for hiding a cover of a valve box is provided. The method includes placing a decoration onto the top of a cover of the valve box to match the surrounding ground cover.

Other features that are considered as characteristic for the invention are set forth in the appended claims.

Although the invention is illustrated and described herein as embodied in a camouflaged cover assembly, the invention should not be limited to the details shown in those embodiments because various modifications and structural changes may be made without departing from the spirit of the invention while remaining within the scope and range of equivalents of the claims.

The construction and method of operation of the invention and additional objects and advantages of the invention is best understood from the following description of specific embodiments when read in connection with the accompanying drawings.

### BRIEF DESCRIPTION OF THE SEVERAL VIEWS OF THE DRAWING

FIG. 1 is a cross sectional view of a popup sprinkler with a camouflaged cover assembly according to the invention.

FIG. 2 is a perspective view of the camouflaged cover assembly shown in FIG. 1.

FIG. 3 is a top elevational view of the camouflaged cover assembly shown in FIG. 1.

FIG. 4 is a top elevational view of an embodiment of a camouflaged cover assembly with a number printed thereon.

FIG. 5 is a top elevational view of an embodiment of the camouflaged cover assembly with woodchips disposed thereon.

FIG. 6 is a top perspective view of a valve box covered with a camouflaged cover assembly.

FIG. 7 is an exploded perspective view of the camouflaged cover assembly shown in FIG. 2.

FIG. 8 is an exploded perspective view of the camouflaged cover assembly shown in FIG. 4.

FIG. 9 is a perspective view of a cover for a valve box with a concrete cover.

FIG. 10 is a perspective view of a valve box to be used with the cover shown in FIG. 9.

FIG. 11 is a top elevational view of the valve box shown in FIG. 10.

FIG. 12 is a top elevational view of a manhole covered with an asphalt cover.

FIG. 13 is an exploded perspective view of the manhole cover shown in FIG. 12.

FIG. 14 is a top elevational view of a water meter covered with a brick cover.

### DETAILED DESCRIPTION OF THE INVENTION

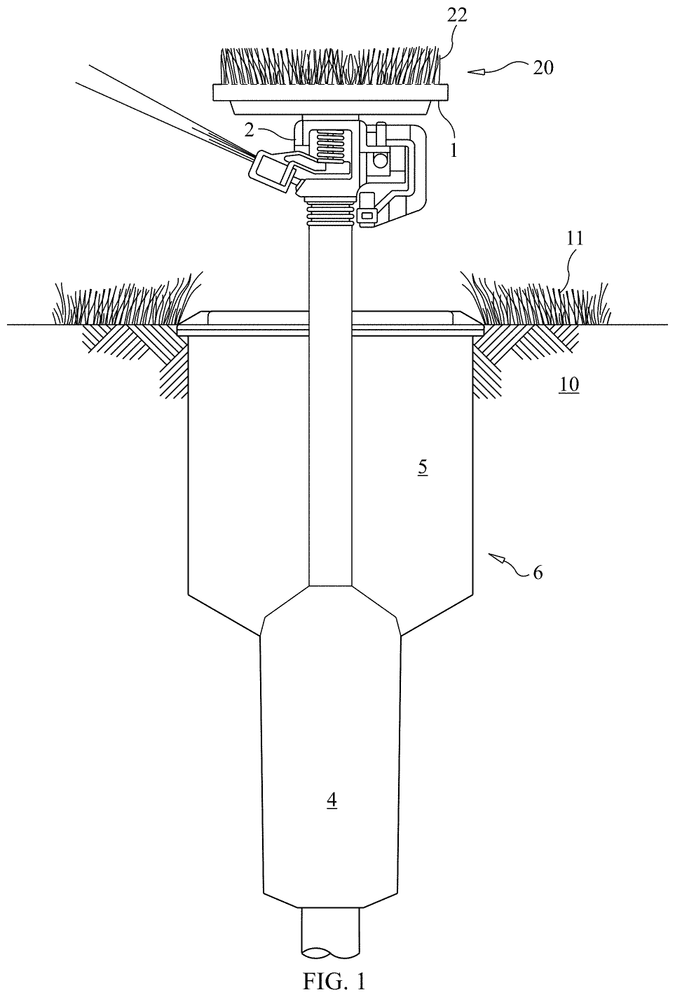

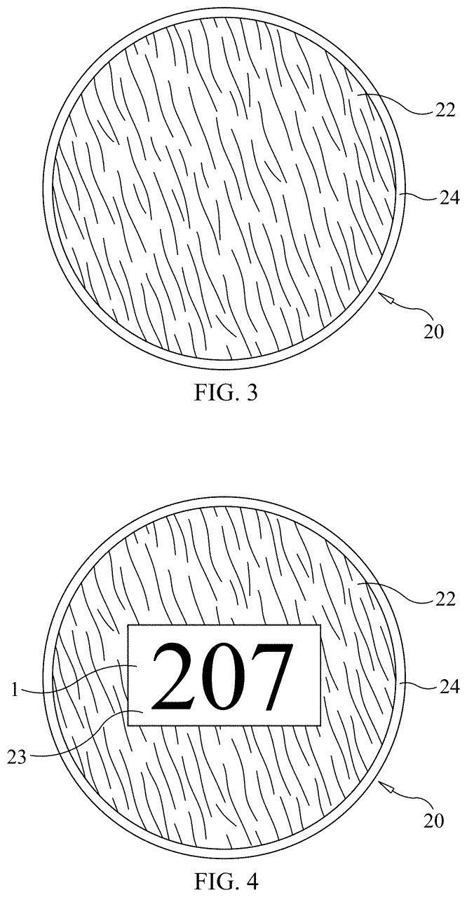

FIGS. 1-3 and 7 show a camouflaged cover assembly 20. The camouflaged cover assembly 20 includes a cover 1. An elastomer layer 21 is disposed on the top surface of the cover 1. Artificial turf 22 is disposed on the cover 1. In this embodiment, the artificial turf 22 completely covers the cover 1. The artificial turf 22 is selected to match the length and variety of the surrounding grass 11.

A preferred embodiment of a popup sprinkler head 6 is connected to the cover 1. The popup sprinkler head 6 includes a housing 5 disposed in the ground 10. A base 4 is disposed in the housing 5. The base 4 is connected to a water supply pipe, which is not shown. When water is supplied to the base 4, water pressure extends a piston 3. As the piston 3 extends, a sprinkler head 2 and cover 1 are pushed above the surface of the ground 10. When the water supply is cut to the base 4, the piston 3 retracts into the base 4 and the cover 1 lowers to the level of ground 10. The artificial turf 22 conceals the cover 1 within the grass 11.

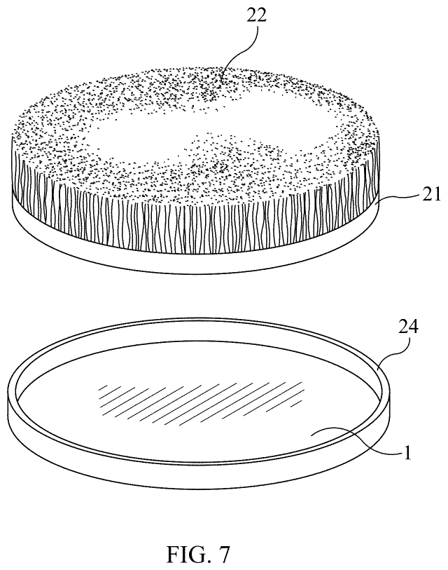

As shown in FIG. 7, the elastomer layer 21 is preferably artificial foam rubber. The elastomer layer 21 has a thickness configured to match the physical qualities including hardness and resilience of the surrounding ground 10 and grass 11.

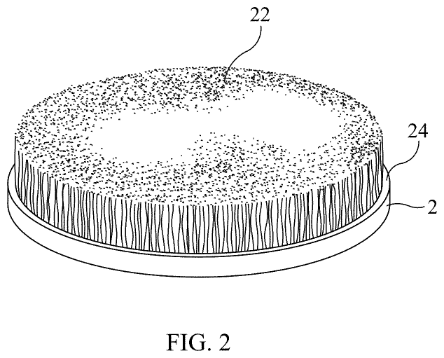

Shown in FIGS. 2, 3, and 7, the cover 1 has a rim 24 extending upward from the perimeter of the cover 1. A decorative unit is formed by a decoration and a foundation. In FIG. 7, the decoration is artificial turf 22 and the foundation is elastomer layer 21. Different decorative units which are configured to match different surrounding materials can be set into the cover 1 and affixed by adhesive or other fastener.

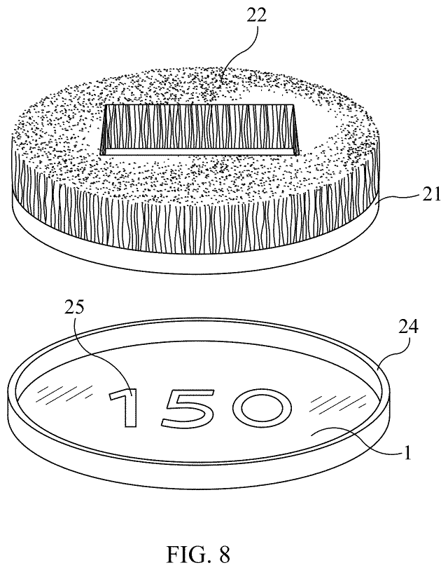

FIGS. 4 and 8 show an embodiment of a camouflaged cover assembly 20. The artificial turf 22 and the elastomer layer 21 have a rectangular cutout 26 formed therein. A number 23 is painted on the top surface of the cover 1. The number 23 is visible through the cutout 26. In the preferred embodiment, the number 23 is a distance from the camouflaged cover assembly 20 to a golf hole, which is not shown.

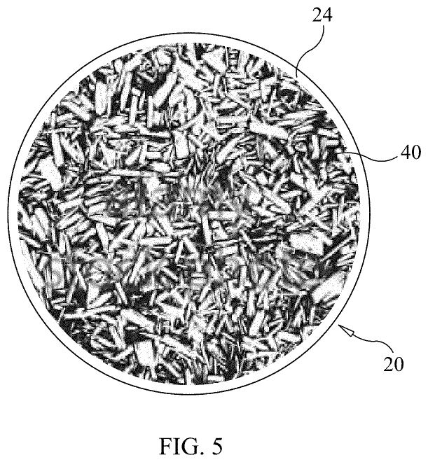

FIG. 5 shows an embodiment of camouflaged cover assembly 20 in which the decorative unit is a mulch decoration 30. The camouflaged cover assembly 20 with the mulch decoration 30 is used to match ground 10 covered with mulch. The mulch decoration 30 is configured to match the color and texture of the mulch covering the surrounding ground.

In an embodiment which is not shown, the camouflaged cover assembly 20 includes a photo image of grass, mulch, or other surrounding ground cover connected to a cover of a sprinkler head or valve box.

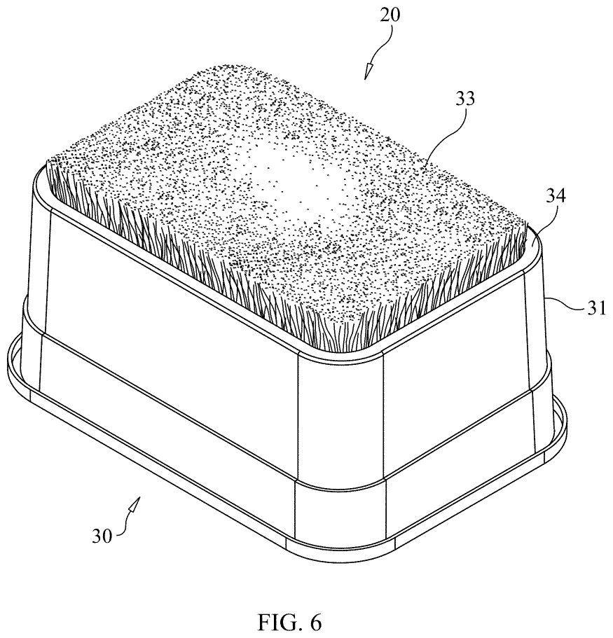

FIG. 6 shows a camouflaged cover assembly 20 for a valve box 30. The valve box 30 is configured to be buried in the ground. The valve box 30 is configured to hold valves and similar pipe fittings, to provide access to the valves and pipe fittings, and to separate those fitting from the surround earth. The valve box 30 has a sidewall 31. The camouflaged cover assembly 20 rests on the sidewall 31 and provides access to the interior of the valve box 30 when removed. The camouflaged cover assembly 20 includes a cover for the valve box 30. The cover has a rim 34 rising from the perimeter of the cover. Artificial turf 33 is disposed on the cover.

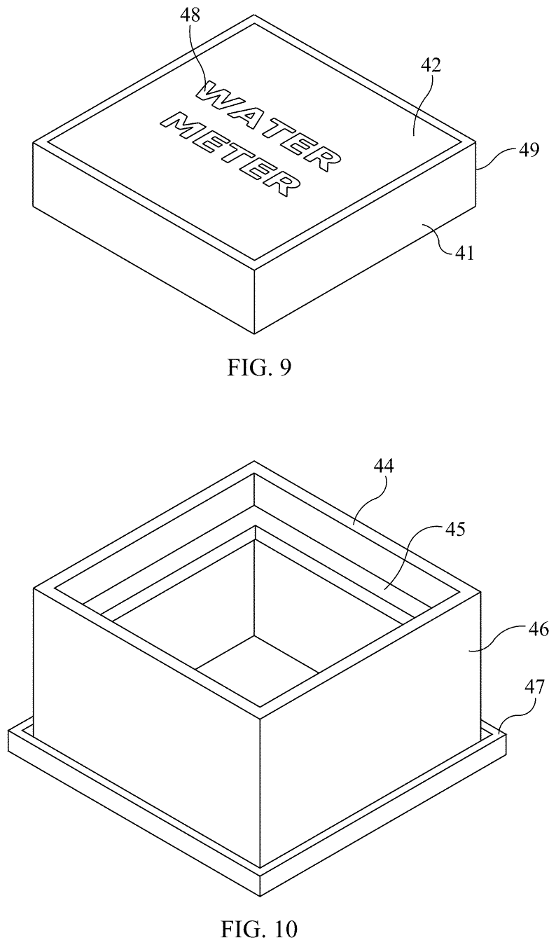

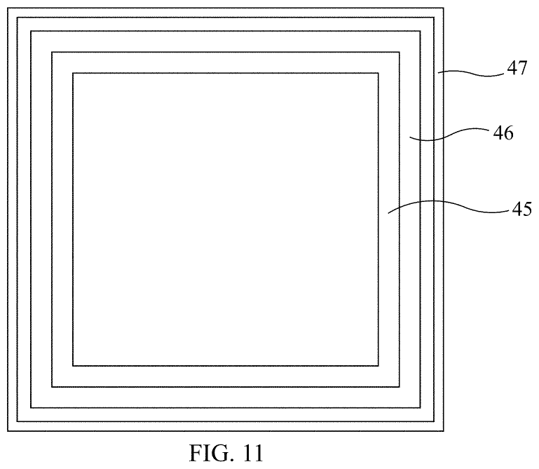

FIGS. 9-11 show an embodiment of the camouflaged cover assembly that includes a square shaped decorative unit that matches surrounding concrete. The decorative unit includes a foundation 41. A concrete layer 42 is adhered to the foundation 41. The concrete layer 42 matches the concrete in surrounding areas. The valve box has a rim 44. The decorative unit rests on a ledge 45 with a top surface of the concrete layer 42 even with a top of the rim 44. The valve box includes a wall 46, which has a rolled edge 47 at the bottom of the wall 46.

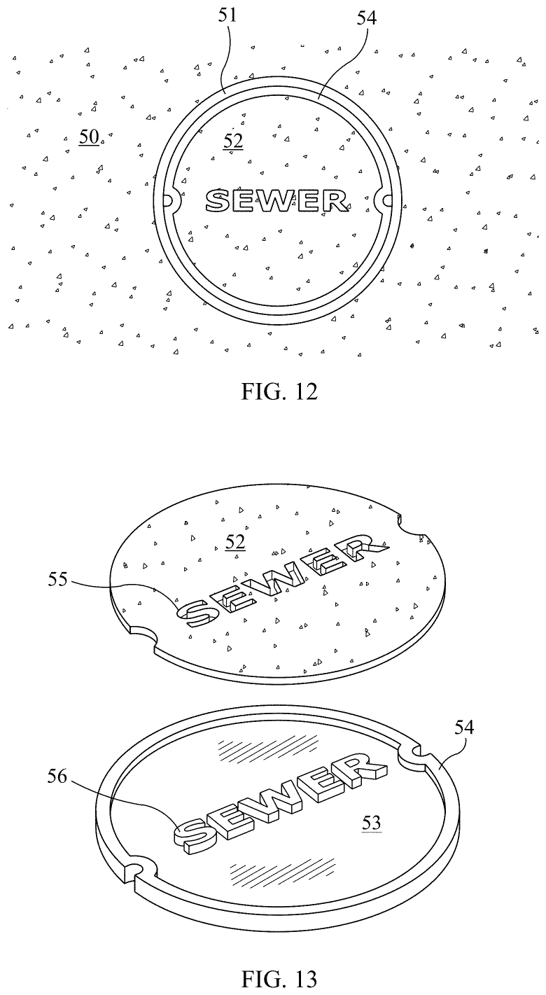

FIGS. 12-13 show an embodiment of the camouflaged cover assembly that is to be used when a surrounding surface is covered with asphalt 50. In the embodiment, a cover 53 has raised letters 56. A rim 54 raises from the perimeter of the cover 53. The top of the rim 54 is at a same height as the top of the raised letters 56. An insert 52 is made of asphalt that matches asphalt 50. The height (i.e. thickness) of the insert 52 equals the height of the rim 54. The insert 52 has a cutout 55 to complement the raised letters 56. The insert 52 is shaped and sized to rest within the rim 54 with the raised letters 56 filling the cutout 55. An adhesive such as tar can be used to adhere the insert 52 to the cover 53.

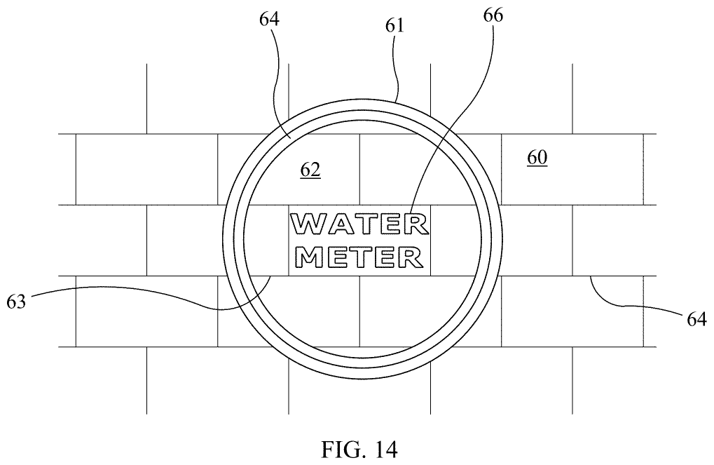

FIG. 14 shows an embodiment of the camouflaged cover assembly that is to be used with a surrounding surface that is covered with bricks, pavers, or cobblestones 64. A water meter valve box is covered by the cover assembly. A metal rim 61 of the water meter valve box is exposed. A rim 64 of the cover sits within the metal rim 61. A layer of bricks, pavers, or cobblestones 62 are placed on the cover. The layer of bricks, pavers, or cobblestones 62 has a thickness equal to the height of the rim 64 so when they are placed on the cover they are flush with the rim 64. Raised letters 66 with a height equal to the rim 64 extend upward from the cover and are visible through cutouts in the bricks, pavers, or cobblestones 62. If the bricks, pavers, or cobblestones are connected with masonry 64, matching masonry 63 can be placed between the bricks, pavers, or cobblestones 62.

The bricks, pavers, or cobblestones 62 can be generic bricks, pavers, or cobblestones that are preconfigured and sold assembled to people who want to camouflage their covers. Alternatively, custom covers can be made from the same materials that surround the covers to produce perfectly matching camouflaged covers.

The above mentioned preferred embodiments provide examples of the invention but the scope of the invention should be judged by the claims themselves and not by the preferred embodiments.

What is claimed is:

1. A camouflaged cover assembly for a box, hole, or conduit placed in ground having a surface, the camouflaged cover assembly comprising:
a cover for limiting access to a box, pipe, or conduit, said cover having a top surface; and
a decoration matching the surface of the ground being disposed on said top surface of said cover.

2. The camouflaged cover assembly according to claim 1, wherein said decoration is artificial turf.

3. The camouflaged cover assembly according to claim 1, wherein said decoration is a plurality of wood chips.

4. The camouflaged cover assembly according to claim 1, wherein said decoration is a piece of cement or concrete.

5. The camouflaged cover assembly according to claim 1, wherein said decoration is a plurality of tiles.

6. The camouflaged cover assembly according to claim 1, wherein said decoration is a photograph matching the surface of the ground.

7. The camouflaged cover assembly according to claim 2, further comprising an elastomer layer disposed between said top surface of said cover and said decoration.

8. The camouflaged cover assembly according to claim 1, wherein said decoration completely covers said top surface of said cover.

9. The camouflaged cover assembly according to claim 1, wherein said top surface of said cover contrast said decoration.

10. A method for camouflaging a box seated in ground, which comprises:
placing a cover on a sidewall of the box;
choosing a decoration to match coverage of the ground surrounding the box; and
disposing said decoration on a top surface of said cover.

11. The method according to claim 10, wherein:
the coverage of the ground is mulch or wood chips; and
said decoration looks like the mulch or wood chips.

12. The method according to claim 10, wherein:
the coverage of the ground is a type of grass; and
said decoration looks like the type of grass.

13. A camouflaged cover assembly, comprising:
a cover for closing an opening to a box, the box being surrounded by a material;
a rim raised from a periphery of said cover, said rim and said cover having a height equal to a distance from a top of the box to a ledge in the box;
a decoration matching the material being placed on a top of said cover; and
a thickness of said decoration being as thick as a height of said rim above said cover.
